(19) United States
(12) Patent Application Publication
(10) Pub. No.: US 2010/0022103 A1
(43) Pub. Date: Jan. 28, 2010

(54) CONNECTOR AND TRANSMISSION WIRE

(75) Inventor: Yoko Murata, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/491,359

(22) Filed: Jun. 25, 2009

(30) Foreign Application Priority Data
Jul. 28, 2008 (JP) 2008-193847

(51) Int. Cl. H01R 12/00; H02G 3/04

(52) U.S. Cl. 439/55; 174/68.1

(57) ABSTRACT

A connector includes a first contact portion, a second contact portion, a housing and a transmission wire. One of a plug and a receptacle is connected to the first contact portion. The second contact portion is connected to a printed wiring board. The housing holds the first and second contact portions. The transmission wire has one end to which the first contact portion is joined and the other end to which the second contact portion is joined.

### CROSS-REFERENCE TO RELATED APPLICATION

This application is based upon and claims the benefit of priority of the prior Japanese Patent Application No. 2008-193847, filed on Jul. 28, 2008, the entire contents of which are incorporated herein by reference.

### FIELD

The present invention relates to a connector and a transmission wire for the connector.

### BACKGROUND

In general, connectors are widely used as apparatus for electrically connecting electronic devices such as servers, switchboards, and host computers. In these electronic devices, when an electrical signal is transmitted at high speed, mixing of noise such as crosstalk noise becomes a problem. Therefore, Japanese Laid-open Patent Publication 2004-111140, for example, discloses that a shielded terminal or a ground terminal is provided between adjacent signal contacts to reduce noise generated at the time of transmission of a radio-frequency signal.

FIG. 1 illustrates such a conventional connector. A connector 1 is provided with, as schematically depicted in FIG. 1, a front portion 4 into which a plug pin (not shown) is inserted and a plurality of contact modules 5 which is attached to the front portion 4.

FIG. 2 illustrates an enlarged contact module 5. The contact module 5 is provided with a molded body 9 in which a plurality of contacts 6 (i.e., six contacts in FIG. 2) are placed. A plug terminal 7 is placed at one end of each contact 6 while a press-fit contact terminal 8 (hereinafter, simply referred to as a PF terminal) is placed at the other end of each contact 6.

The plurality of contacts 6 includes signal contacts 6S and ground contacts 6G. Each of the signal contacts 6S is located between a pair of the ground contacts 6G. This may suppress noise generation when a radio-frequency signal is transmitted.

A plug (not shown) is engaged and unengaged to the front portion 4 of the connector 1 along a direction indicated with the arrow X in FIG. 1. On the other hand, the connector 1 is mounted on a printed wiring board (not shown) along a direction of the arrow Z in FIG. 1. Therefore, the conventional contacts 6 have been formed into a perpendicular L-shape as depicted in FIG. 2.

However, since a plate-like contact member is pressed to form the L-shape contacts 6, a large space for locating the signal contact 6S between the ground contacts 6G is needed. Accordingly, it is difficult to obtain high-density placement of the contacts 6 and miniaturize the connector 1.

Moreover, although the signal contact 6S in a single contact module 5 is located between the ground contacts 6G, the signal contacts 6S in a lateral direction (the arrow Y in FIG. 1) may be neighbored to each other if a plurality of the contact modules 5 is arranged in parallel, thereby interposing noise into the signal contacts 6S.

Furthermore, according to the conventional connector 1, since the X direction where the plug is engaged and unengaged to the connector 1 differs from the Z direction where the connector 1 is mounted to the board, the contact 6 is formed into an L-shape. Therefore, each of the contacts 6 has a different length, and it is difficult to adjust impedance in each contact 6.

### SUMMARY

According to an aspect of the invention, a connector includes: a first contact portion to which one of a plug and a receptacle is connected; a second contact portion connected to a printed wiring board; a housing holding the first and second contact portions; and a transmission wire housed in the housing. The transmission wire has one end to which the first contact portion is joined and the other end to which the second contact portion is joined.

It is to be understood that both the foregoing general description and the following detailed description are exemplary, and do not restrict the invention as claimed.

### BRIEF DESCRIPTION OF DRAWINGS

The above and other objects, features and advantages of the present invention will become apparent from the following description of the embodiments in conjunction with the accompanying drawings, wherein:

FIG. 1 is a perspective view of a conventional connector;

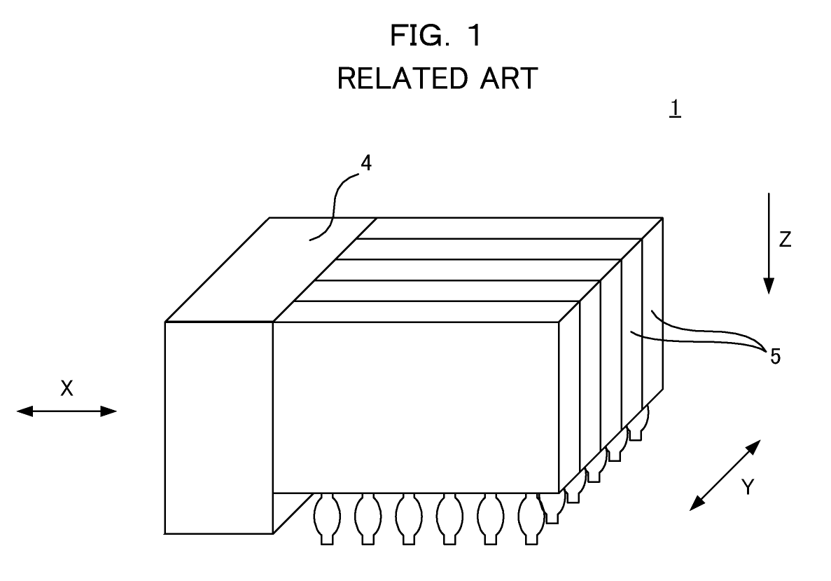

FIG. 2 is an enlarged perspective view of a conventional contact module in the conventional connector;

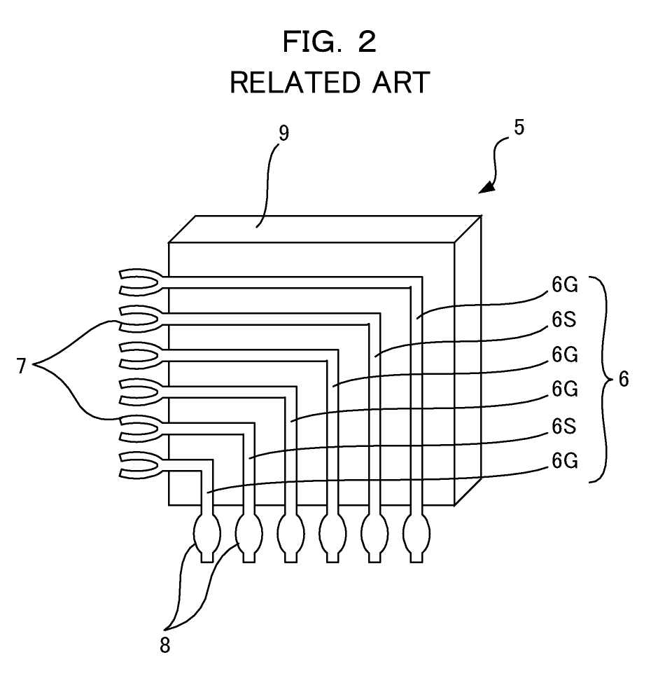

FIG. 3 is a transparent view of a connector according to a first embodiment of the invention;

FIG. 4 is a perspective view of the connector according to the first embodiment;

FIG. 5 illustrates a transmission wire attached to the connector according to the first embodiment;

FIG. 6 is a front view of the transmission wire according to FIG. 5;

FIG. 7 illustrates a transmission wire attached to the connector according to a second embodiment of the invention;

FIG. 8 is a front view of the transmission wire according to FIG. 7;

FIGS. 9A to 9D illustrate an engagement structure between a signal wire and a contact;

FIGS. 10A to 10D illustrate another engagement structure between a signal wire and a contact;

FIG. 11 is a perspective view of a connector according to the second embodiment;

FIG. 12 is an perspective view of a contact module in the connector according to the second embodiment;

### DESCRIPTION OF EMBODIMENTS

Embodiments of the present invention will be described hereinafter with reference to the accompanying drawings.

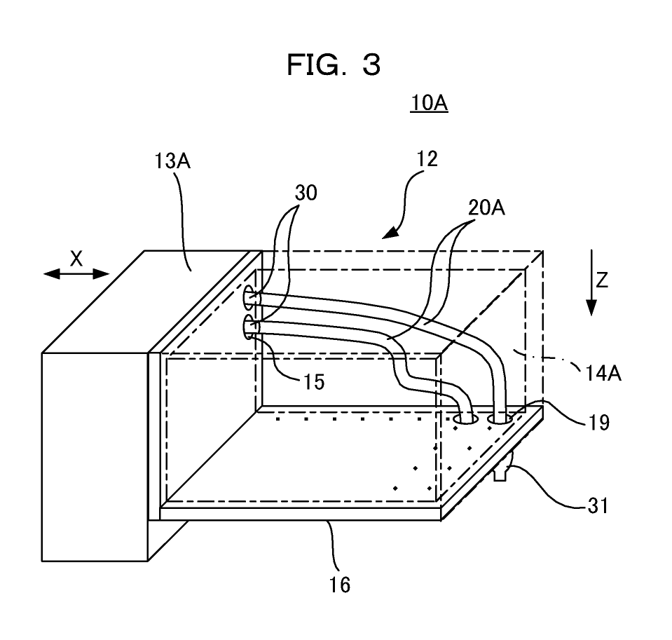

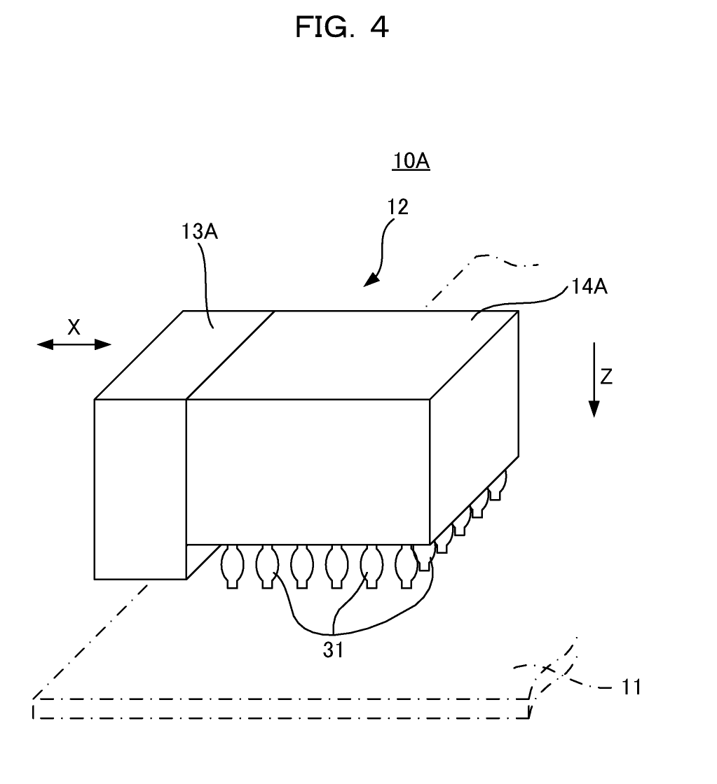

FIGS. 3 and 4 are diagrams for explaining a connector 10A which is a first embodiment of the invention. FIG. 3 is a transparent view of the connector 10A. FIG. 4 is a perspective view showing the external appearance of the connector 10A which is mounted on a printed wiring board 11.

The connector 10A is provided with a housing 12 and a transmission wire 20A. In addition, the housing 12 is provided with a front portion 13A and a housing body 14A.

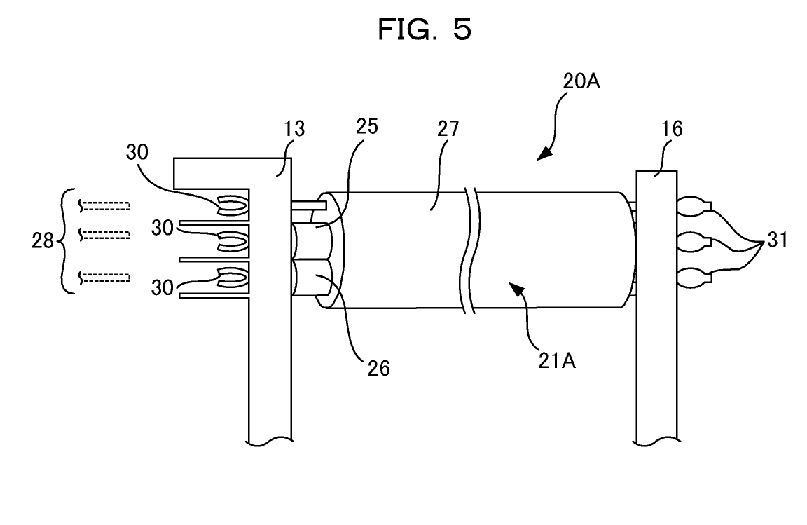

The front portion 13A is a part through which a plug 28 (see FIG. 5) is engaged and unengaged, and is provided with a plurality of plug insertion holes 15. It is to be noted that only two plug insertion holes 15 are illustrated in FIG. 3 as a matter of convenience. The plug 28 is engaged and unengaged through the front portion 13A along a direction of the arrow X in FIG. 3, and is electrically connected to a plug contact 30, which will be described later. Incidentally, the front portion 13A may be formed of insulating rigid resin.

In the first embodiment, the housing body 14A has a shape of enclosure inside which a space is provided. In FIG. 3, a bottom portion 16 of the housing body 14A is indicated by solid lines while the contour of the housing body 14A is indicated by dashed-dotted lines. The bottom portion 16 is provided with a plurality of contact attachment holes 19 through which a plurality of board contacts 31, which will be described later, are placed. As with the front portion 13A, the housing body 14A may be formed of insulating rigid resin. Incidentally, the housing body 14A may be fixed to the front portion 13A, or may be so configured as to be detachable from the front portion 13A.

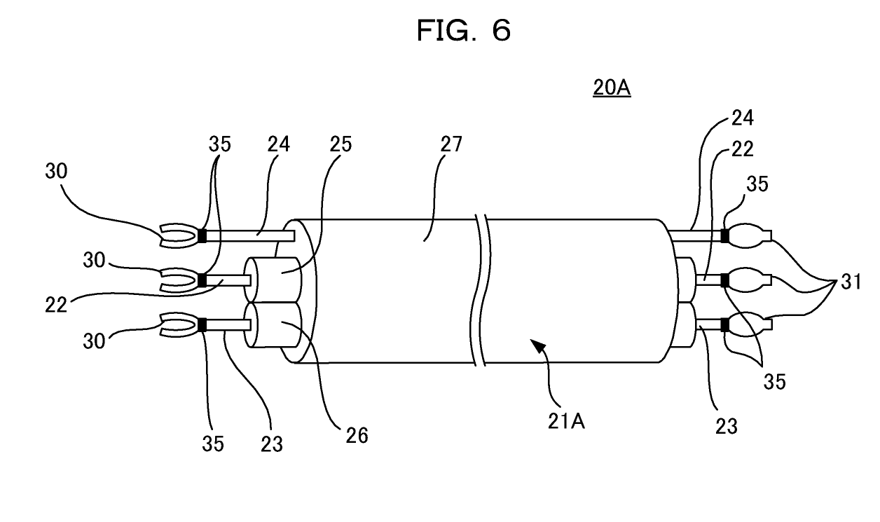

Next, the transmission wire 20A will be described. FIG. 5 illustrates a transmission wire 20A attached to the connector 10A according to the first embodiment. FIG. 6 is a front view of the transmission wire 20A.

In the first embodiment, the transmission wire 20A has a twinaxial cable (i.e., twinax) structure in which two inner conductors are provided. The transmission wire 20A includes a wire body 21A, the plug contact 30 and the board contact 31.

A signal wire 22 is covered by an insulating material 25, and a signal wire 23 is covered by an insulating material 26. The signal wires 22 and 23 are covered by a reticular shielding member (not shown). The reticular shielding member may be obtained by weaving conductive thin wires which are electrically connected to a ground wire 24. The wire body 21A further covers the signal wires 22 and 23 and the ground wire 24 with a jacket 27 of insulating resin. Since the insulating materials 25 and 26, the signal wires 22 and 23, the shielding material connected to the ground wire 24, and the jacket 27 have flexibility respectively, the wire body 21A is also flexible.

According to the first embodiment, the transmission wire 20A (the wire body 21A) has a twinax structure as described above, it is suitable for transmitting a high-speed digital signal. Specifically, signal outputs may be doubled at the receiving end by simultaneously inputting and transmit signals of 180 degrees phase-reversal toward the signal wires 22 and 23 to synthesize the differences at the receiving end. (i.e., differential transmission) Moreover, although a noise signal is received in the middle of the transmission path which extends from signal transmission to signal reception, the noise signal is equally divided to the two inner conductors, and the noise signal is cancelled out when the differential signal is outputted at the receiving end. In this way, noise signals may be effectively removed.

Next, the plug contact 30 and the board contact 31 in the transmission wire 20A will be explained.

The plug 28 placed in a plug connector (not shown) is connected to the plug contact 30 when the plug connector is attached to the connector 10A. Moreover, the board contact 31 is connected to the printed wiring board 11 on which the connector 10A is mounted. The connector 10A according to this embodiment has a press-fit connector structure. Therefore, the board contact 31 is a press-fit contact.

Furthermore, the plug contact 30 and the board contact 31 are formed of a material (such as phosphor bronze) having electro-conductivity and springiness. The plug contact 30 is joined to one end portion (a left-hand end portion in FIGS. 5 and 6) of each of the signal wires 22 and 23 and the ground wire 24 while the board contact 31 is joined to the other end portion (a right-hand end portion in FIGS. 5 and 6) of each of the signal wires 22 and 23 and the ground wire 24. In addition, the signal wires 22 and 23 and the contacts 30 and 31 are joined by soldering or the like, which will be described later.

The plug contact 30 structured as described above is press-fitted into the plug insertion hole 15 formed in the front portion 13A and thereby held by the front portion 13A (the housing 12). On the other hand, the board contact 31 is press-fitted into the contact attachment hole 19 formed in the bottom portion 16 and thereby held by the housing body 14A (the housing 12).

As depicted in FIG. 3, the connector 10A according to this embodiment is configured such that the plug 28 is engaged and unengaged to the front portion 13A along the direction of the arrow X, and the housing 12 is attached to the board along the direction of an arrow Z. That is, the X direction in which the plug 28 is engaged and unengaged to the plug contact 30 is proximately orthogonal to the Z direction in which the board contact 31 is connected to the board. Therefore, such a configuration inevitably makes it necessary to bend a wire connecting the plug contact 30 and the board contact 31.

In this embodiment, the contacts 30 and 31 are connected to each other by bending the wire body 21A of the transmission wire 20A. As described above, since the wire body 21A has flexibility, the wire body 21A may be bended with ease between the contacts 30 and 31.

Furthermore, in this embodiment, a plurality of wire bodies 21A disposed in the housing body 14A may have the same length. As described above, the contacts 30 and 31 are located in various positions at the front portion 13A and the bottom portion 16, respectively, and therefore the linear distance between a pair of contacts 30 and 31 may differ from another pair of contacts 30 and 31 in accordance with locations. However, since the wire body 21A has flexibility, the wire bodies 21A can be bended as depicted in FIG. 3, and each of the wire bodies 21A has the same length despite the different locations.

As described above, by making all of the plurality of the wire bodies 21A connecting the contacts 30 and 31 have the same length, it is possible to match the impedance of all the wire bodies 21A (the signal wires 22 and 23) equally. Therefore, with the connector 10A and the transmission wire 20A according to this embodiment, it is possible to match the impedance of the contacts 30 and 31 with ease, and prevent interposition of extrinsic noises and the occurrence of signal interference in the connector 10A. Moreover, in the configuration of this embodiment, although a large number of transmission wires 20A (wire bodies 21A) is proximally disposed in the housing body 14A, interferences between the adjacent transmission wires 20A may be prevented due to the twinax cable structure of the transmission wire 20A.

In the embodiment, the twinax cable structure (i.e., the parallel signal wires 22 and 23 which are respectively covered with the insulating materials 25 and 26) has been described. However, the structure of the transmission wire 20A is not limited thereto, and a twisted pair cable structure in which the signal wires 22 and 23 which are respectively covered with the insulating materials 25 and 26 are twisted together may be employed alternatively. Furthermore, various types of transmission wire for high-speed transmission such as a coaxial cable, a pair cable, a shielded twisted pair cable, and a shielded pair cable, may be employed.

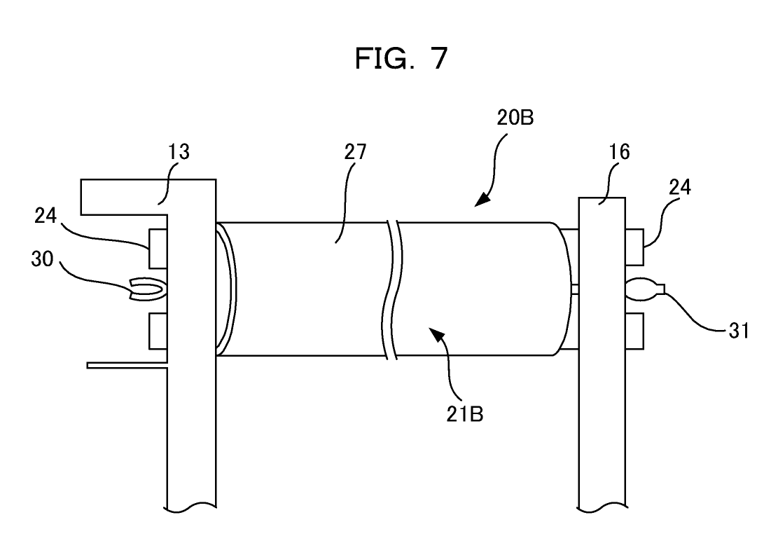

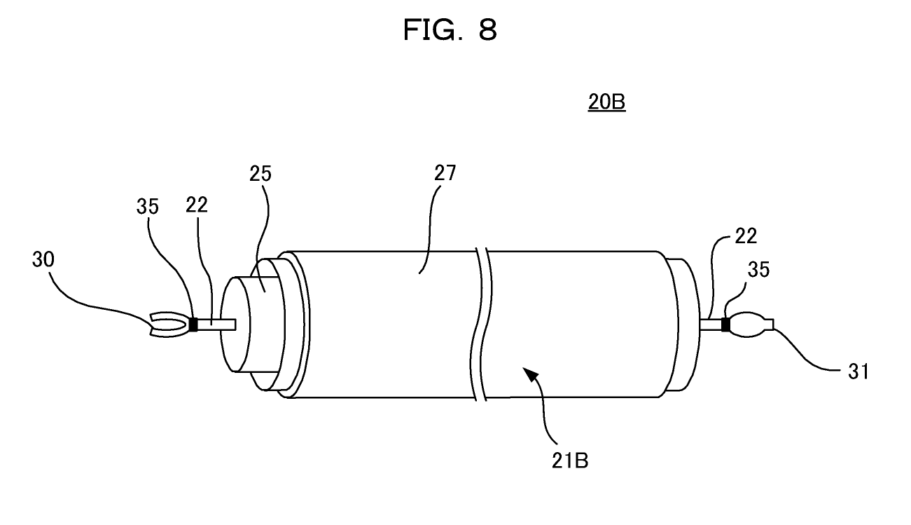

As a second embodiment of the invention, FIG. 7 illustrates a coaxial transmission wire 20B attached to the connector 10A. FIG. 8 is a front view of the coaxial transmission wire 20B.

The transmission wire 20B includes a wire body 21B, a plug contact 30, a board contact 31, and the like. The wire body 21B has a coaxial cable structure, in which a signal wire 22 is covered with an insulating material 25, and a net-like ground wire 24 obtained by weaving conductive thin wires is placed around the insulating material 25. Furthermore, the outer surface of the ground wire 24 is covered with a jacket 27 formed of insulating resin.

The signal wire 22, the insulating material 25, the ground wire 24, and the jacket 27, which together form the wire body 21B, have flexibility. Moreover, even when the wire bodies 21B are placed in the housing body 14A in such a way that they lie close to each other, due to the presence of the ground wire 24, no interference occurs between the adjacent wire bodies 21B. Therefore, instead of the transmission wire 20A having a twinax cable structure, it is possible to employ the transmission wire 20B having a coaxial cable structure.

Moreover, in the above-described embodiment, the transmission wire 20A is housed in the space inside the housing body 14A. However, it is also possible to mold the housing body and bury the transmission wire 20A in it. By doing so, it is possible to prevent the transmission wires 20A from sliding and making contact with each other in the housing body 14A, and causing time degradation. Moreover, by mixing a conductive filler in the resin forming the housing body, it is possible to enhance shielding ability.

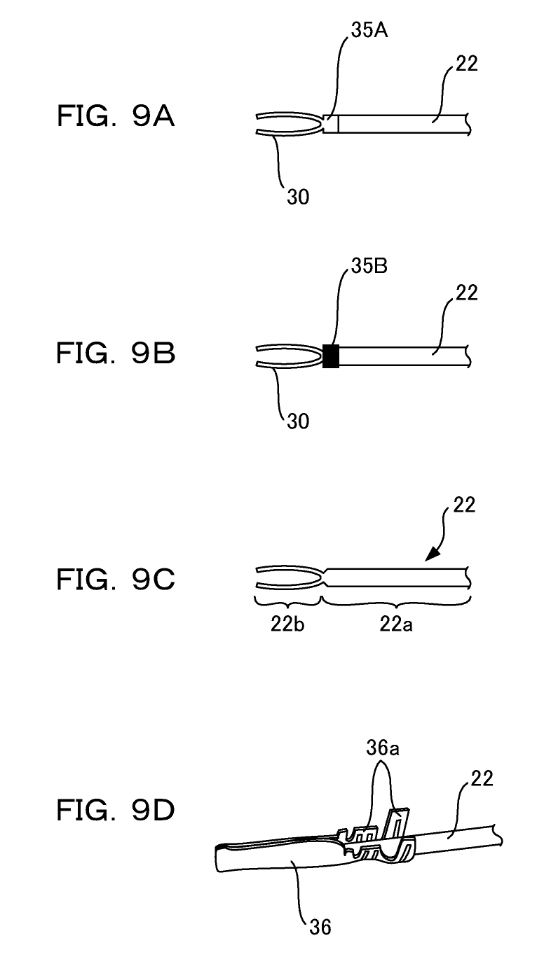

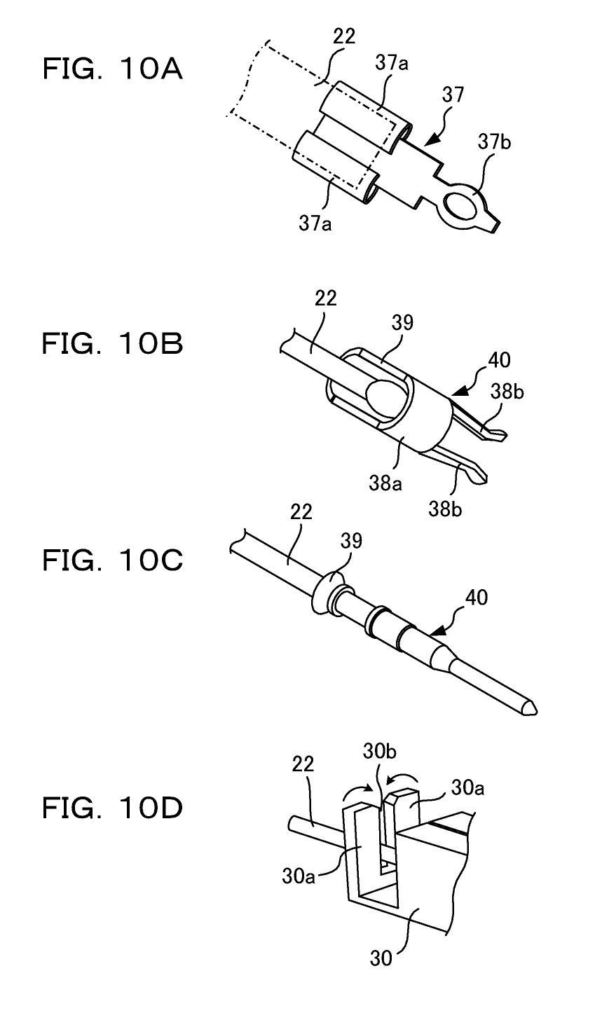

Next, a structure to join the contacts 30 and 31 to the signal wires 22 and 23 will be explained. FIGS. 9A to 9D and 10A to 10D show various joint structures to join the contacts 30 and 31 to the signal wires 22 and 23. Incidentally, the following explanation deals with a structure to join various contacts to the signal wire 22.

A joint structure depicted in FIG. 9A depicts a structure to join the plug contact 30 having a mechanical joint 35A to the signal wire 22. The mechanical joint 35A can join the signal wire 22 and the plug contact 30 mechanically by soldering or caulking. This joint structure makes it possible to join the signal wire 22 and the plug contact 30 firmly.

Moreover, a joint structure depicted in FIG. 9B joins the signal wire 22 and the plug contact 30 with a resin joint 35B. As the resin joint 35B, an adhesive having conductivity, for example, can be used. This joint structure is suitable for automatization, and can join the signal wire 22 and the plug contact 30 with a high degree of production efficiency.

Furthermore, a joint structure depicted in FIG. 9C is a structure in which a material having conductivity and springiness is used as a material for the signal wire 22, and a wire portion 22a functioning as a wire and a contact portion 22b functioning as a contact are formed integrally with it. The contact portion 22b can be used as the plug contact 30 or the board contact 31. According to this joint structure, since the wire portion 22a and the contact portion 22b are jointed integrally, a signal loss or a change in impedance is less likely to occur in this joint position, making it possible to prevent degradation in signal transmission characteristics.

In addition, a joint structure depicted in FIG. 9D is a structure in which a contact is formed as a receptacle 36, and the receptacle 36 and the signal wire 22 are joined by a caulking portion 36a formed in the receptacle 36. Therefore, the present invention can be applied to a connector to which a receptacle is connected.

Moreover, a joint structure depicted in FIG. 10A is a structure in which a contact is formed as a press-fit contact 37 with a contact portion 37b, and the press-fit contact 37 and the signal wire 22 are joined by a caulking portion 37a formed in the press-fit contact 37. Furthermore, a joint structure depicted in FIG. 10B is a structure in which the signal wire 22 is joined to a receptacle 38 by using solder 39, the receptacle 38 having a body portion 38a with a contact portion 38b.

In addition, a joint structure depicted in FIG. 10C is a structure in which a plug pin 40 is used as a contact, and the signal wire 22 is joined to the plug pin 40 by using solder 39. Furthermore, a joint structure depicted in FIG. 10D is a structure in which the plug contact 30 has a slit 30b between a pair of lug portions 30a, and, by press-fitting the signal wire 22 into the slit 30b and thereby cutting the covering at the slit 30b, a core wire of the signal wire 22 and the plug contact 30 are joined. As described above, various structures can be adopted as a joint structure to join the signal wire 22 and the contacts 30 and 31.

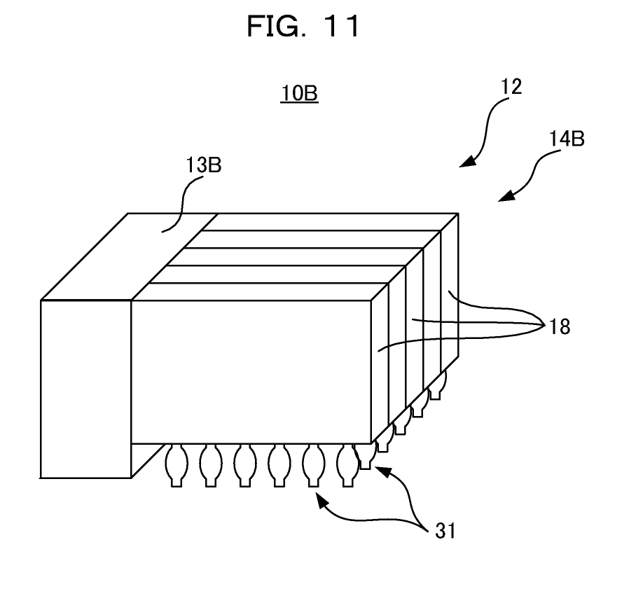

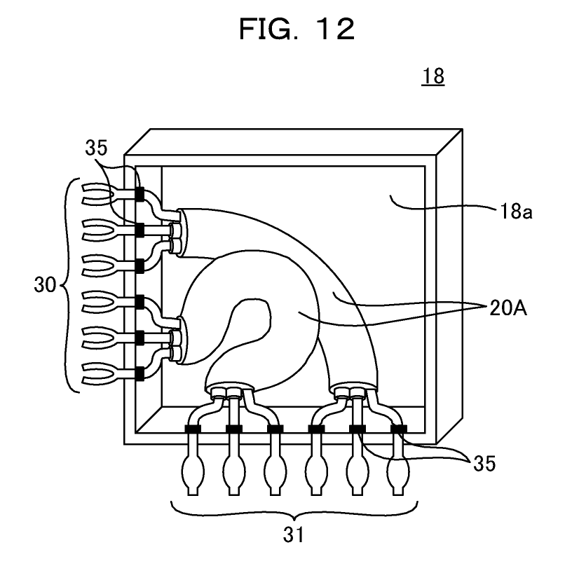

Next, a connector 10B according to the second embodiment of the invention will be explained with reference to FIGS. 11 and 12.

In the connector 10A according to the first embodiment depicted in FIGS. 3 and 4, the housing body 14A is formed as a single enclosure-shaped member, and the transmission wire 20A is housed in the space inside it. On the other hand, in the connector 10B according to this embodiment, a housing body 14B is formed with a plurality of contact modules 18, and the housing body 14B can be attached to and detached from a front portion 13B.

FIG. 12 illustrates an enlarged contact module 18. The contact module 18 houses a plurality of transmission wires in a housing portion 18a formed inside the contact module 18. In this embodiment, for the sake of illustration, only two of them are depicted in the figure; however, the number is not limited thereto. In this embodiment, as a transmission wire, the transmission wire 20A (see FIGS. 5 and 6) having a twinax cable structure is used.

Also in this embodiment, the transmission wires 20A housed in the housing portion 18a are made to have the same length. As a result, when the plug contact 30 and the board contact 31 lie close to each other on the contact module 18, the amount of bending of the transmission wire 20A increases; on the other hand, when the plug contact 30 and the board contact 31 lie at a distance from each other, the amount of bending of the transmission wire 20A decreases (the transmission wire 20A approaches a straight line). As described above, the invention can be applied to the connector 10B having a plurality of contact modules 18, and, as is the case with the connector 10A according to the first embodiment, it is possible to make it easy to match the impedance of the signal wires 22 and 23, prevent interposition of extrinsic noises, and prevent signal interference from occurring in the connector.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. A connector comprising:
a first contact portion to which one of a plug and a receptacle is connected;
a second contact portion connected to a printed wiring board;
a housing holding the first and second contact portions; and
a transmission wire housed in the housing, the transmission wire having one end to which the first contact portion is joined and the other end to which the second contact portion is joined.

2. The connector according to claim 1, wherein a plurality of transmission wires is disposed in the housing, and each of the plurality of transmission wires have the same length.

3. The connector according to claim 1, wherein a direction in which the plug is inserted into the first contact portion differs from a direction in which the second contact portion is connected to the printed wiring board.

4. The connector according to claim 1, wherein the second contact portion is a press-fit contact.

5. The connector according to claim 1, wherein the transmission wire is formed of a material having electro-conductivity, and the transmission wire is integrally formed with at least one of the first contact portion and the second contact portion.

6. The connector according to claim 1, wherein the housing is formed of resin material, and the transmission wire is embedded in the housing.

7. The connector according to claim 1, wherein the housing is provided with a front portion and a plurality of contact modules attached to the front portion, and at least one of said transmission wire is disposed within each of the contact modules.

8. The connector according to claim 1, wherein
the transmission wire has a structure of one of a coaxial cable, a twinaxial cable, a twisted pair cable, a pair cable, a shielded twisted pair cable and a shielded pair cable.

9. A transmission wire, comprising:
a first contact portion;
a second contact portion; and
a transmission wire body having one end to which the first contact portion is joined and the other end to which the second contact portion is joined.

10. The transmission wire according to claim 9, wherein the second contact portion is a press-fit contact.

11. The transmission wire according to claim 9, wherein the transmission wire body is formed of a material having electro-conductivity, and the transmission wire body is integrally formed with at least one of the first contact portion and the second contact portion.

12. The transmission wire according to claim 9, wherein
the transmission wire body has a structure of one of a coaxial cable, a twinaxial cable, a twisted pair cable, a pair cable, a shielded twisted pair cable and a shielded pair cable.
